(19) United States
(12) Patent Application Publication
(10) Pub. No.: US 2006/0012720 A1
(43) Pub. Date: Jan. 19, 2006

(54) Audio system circuitry for automatical sound level control and a television therewith

(76) Inventor: Rong-Hwa Ding, Jubei City (TW)

Correspondence Address: J C PATENTS, INC., 4 VENTURE, SUITE 250, IRVINE, CA, 92618, US

(21) Appl. No.: 10/890,929

(22) Filed: Jul. 13, 2004

(51) Int. Cl. H04N 5/60

(52) U.S. Cl. 348/738

(57) ABSTRACT

In TV broadcasting environment, due to different settings in different TV stations, the sound level from each station may vary in a wide range. For general users, it may cause annoying experience since the TV sound level may change a lot when user switches the channel from one to the other. In addition, switching among TV reception and AV inputs may have similar problem. The present invention relates to a method and apparatus which can be easily integrated into a single IC to achieve a low cost TV sound level control solution.

### BACKGROUND OF THE INVENTION

1. Field of the Invention

The invention relates in general to an audio system circuitry and a television therewith, and more particularly, to an audio system circuitry for automatically sound level control and a television therewith.

2. Related Art of the Invention

In a television (TV) broadcasting environment, due to different settings in different TV stations, a sound level from each of the TV stations may vary in a wide range. For general users, it may cause annoying experience since the sound level in the TV stations may change a lot when a user switches channels from one to the other. In addition, switching among a TV reception and AV inputs may have similar problem.

For solving the problem, an “apparatus for automatically adapting the mean sound level of a television receiver” is proposed in the U.S. Pat. No. 5,631,714, assigned to Serge Saadoun on May 20, 1997. The apparatus for automatically adapting the sound level of the television receiver includes a video adapting circuit including at least one additional input high-pass filter and a fixed-gain video amplifier connected in series and interposed in the video image processing circuits at circuitry for providing video image signals, and secondly an audio adapting circuit interposed in the sound path at circuitry for taking audio signals to detect the input mean level of sound, to compare said mean level of sound with a pre-established reference mean level, and automatically to adapt the mean level of output sound to maintain it at the pro-established reference mean level.

However, the proposed apparatus for automatically adapting the sound level of the television receiver is implemented purely by analog circuits. It needs manufactures to preset a preferred sound level for users in manufacturing process. However, such preset level may be not an expected level for some end-users. In addition, the sound level detection is implemented at the audio signal input, instead of the audio signal output. At the audio signal input, the signal level is much smaller than signal at output. It is difficult to get accurate adjustment and some small difference remains at such stage. Since the actual audio output is generated after a volume control processing, the final output level may be varied in a wider range due to different volume control settings and the small signal difference at the input after such adjustment. Finally, since the proposed apparatus for automatically adapting the sound level is a pure analog design, it is not easy to be applied to the new digitalized TV designs, which becomes a main trend for future TV.

Another “method and apparatus for maintaining uniform sound volume for televisions and other systems” is proposed in the U.S. Pat. No. 6,552,753, assigned to Ilya Zhurbinskiy, et al. on Apr. 22, 2003. The proposed apparatus includes an eight-bit DSP having a CPU, RAM and ROM memory, an analog digital convertor, a voltmeter, a timer, a switch, and a “SAVE” button. When the user begins listening to a first channel, the user experiments with the volume desired and once the user has it the user pushes the “SAVE” button on the TV set which activates the voltmeter to measure the volume of the tension on the output of the sound amplifier, and correspondingly the loudness level, at a number of intervals to capture variations occurring during the show. The DSP calculates a mean volume of the tension which is then transmitted to the RAM and retained in memory. Then the DSP switches off the apparatus. When the user subsequently switches to a second channel the apparatus switches on and the voltmeter measures the volume of the tension of the second channel at a number of intervals, the digital signal processor calculates the mean level and once again transmits that mean volume of the tension level to the RAM. The DSP calculates the difference between the mean volume of the tension of the saved tension and that of the second channel. If there is a difference in volumes of the tension level, the DSP sends a signal to the apparatus to adjust the volume of the tension until the difference becomes zero.

However, the proposed method and apparatus for maintaining uniform sound volume for televisions uses a DSP after the audio signal multiplexer unit to calculate the sound level and performs adjustment. The proposed architecture needs a higher cost since a dedicated DSP is needed in the system. Furthermore, since some running time is needed for the DSP firmware to do calculation, the proposed architecture measures approximately 5 to 10 times of the volume levels with large interval for adjustment judgment. It may cause erroneous result because sometimes all these data are sampled at higher than average points or are sampled at lower than average points.

### SUMMARY OF THE INVENTION

Accordingly, one object of the present invention is to provide an architecture which can be easily integrated into a single integrated circuit (IC) to achieve a low cost sound level control solution in audio system circuitry applications or electrical devices with an audio system circuitry, for example, in a television (TV) or a car audio system.

To achieve these and other advantages and in accordance with the purpose of the invention, as embodied and broadly described herein, the invention provides an audio system circuitry for sound level control. The audio system circuitry includes an analog to digital converter, a data processing digital circuit, and a storage unit. The analog to digital converter is used for sensing a volume level in the audio system circuitry and output sensing results. The data processing digital circuit is used for performing a calculation upon the sensing results and sending calculation results to the storage unit, whereby the sound level of the audio system circuitry is controlled in according to the calculation results.

In the audio system circuitry above, the audio system circuitry is installed in a television (TV) set and is connected to a TV microcontroller (TV MCU) of the TV set, or a processing unit of the electrical device.

In the audio system circuitry above, the calculation performed by the digital circuit is a mean value calculation. The mean value calculation is done with a sampling rate higher than 1 KHz.

In the audio system circuitry above, the calculation performed by the digital circuit is a peak value memorizing calculation.

In the audio system circuitry above, the calculation performed by the digital circuit comprising two sets of calculation circuits with different programmable periods, wherein one is used for quick adjust and the other is used for fine tune.

In the audio system circuitry above, the audio system circuitry for sound level control is integrated with audio multiplexer, volume control, tone control into a single integrated circuit (IC).

In the audio system circuitry above, the audio system circuitry for sound level control is integrated with audio multiplexer, volume control, tone control into a single integrated circuit (IC).

In the audio system circuitry above, the audio system circuitry for sound level control is integrated with audio multiplexer, volume control, tone control, system processor, and other audio effect processing into a single integrated circuit (IC).

### BRIEF DESCRIPTION OF THE DRAWINGS

These, as well as other features of the present invention will become more apparent upon reference to the drawings.

FIG. 1 shows a preferred embodiment of a digital television (TV) set capable of automatically controlling a sound level.

FIG. 2 shows a preferred embodiment of architecture to achieve a low cost sound level control solution in a television (TV).

FIG. 3 shows a preferred embodiment of the data processing unit shown in FIG. 2, which is implemented by an average calculation circuit.

FIG. 4 shows a preferred embodiment of the data processing unit shown in FIG. 2, which is implemented by a 2-stage average calculation circuit.

### DETAILED DESCRIPTION OF THE PREFERRED EMBODIMENT

The invention provides an architecture which can be easily integrated into a single integrated circuit (IC) to achieve a low cost sound level control solution in audio system circuitry applications or electrical devices with an audio system circuitry, for example, in a television (TV) or a car audio system. The proposed architecture converter for sensing an output volume level in the audio system circuitry application, and a storage unit for storing user settings and calculation results from the digital circuit.

In an embodiment of the invention, the data processing digital circuit performs the calculation including, for example, either a peak value memorizing calculation or a mean value calculation during a user-programmable period, or both. In an embodiment of the invention, the mean value calculation of the proposed architecture is done with a sampling rate higher than 1K Hertz for a more accurate result of the mean value. In an embodiment of the invention, the digital circuit for sound level sense and control includes two sets of calculation circuits with different programmable period, one of which is used for quick adjustment and the other of which is used for fine tune.

In an embodiment of the invention, the proposed architecture for sound level control includes a digital circuit together with an analog to digital converter and a storage unit to constitute a simple and low cost audio sound level sense and control mechanism can be implemented with the audio multiplexer, volume control, tone control in a single integrated circuit.

With the help of data processing digital circuit, system processor (e.g. a TV MCU) can be released from the heavy-duty averaging calculation but only read calculation results and performs suitable adjustment. Since almost all modern audio system circuitries include processor unit and this proposed architecture requests very limited extra processing power to the processor, the processor in the original design does not have to be upgraded to a higher performance. And thus additional cost for achieve such sound level control is minimized. In addition, very efficient application-specific hardware design can be used in the data processing digital circuit. A high sampling rate, for example, 20 KHz, for average calculation or peak value memorizing can be easily achieved to greatly reduce the judgment error from low sampled data number with low sampling rate and large interval, which is a common drawback if calculation is done by firmware of a DSP or processor.

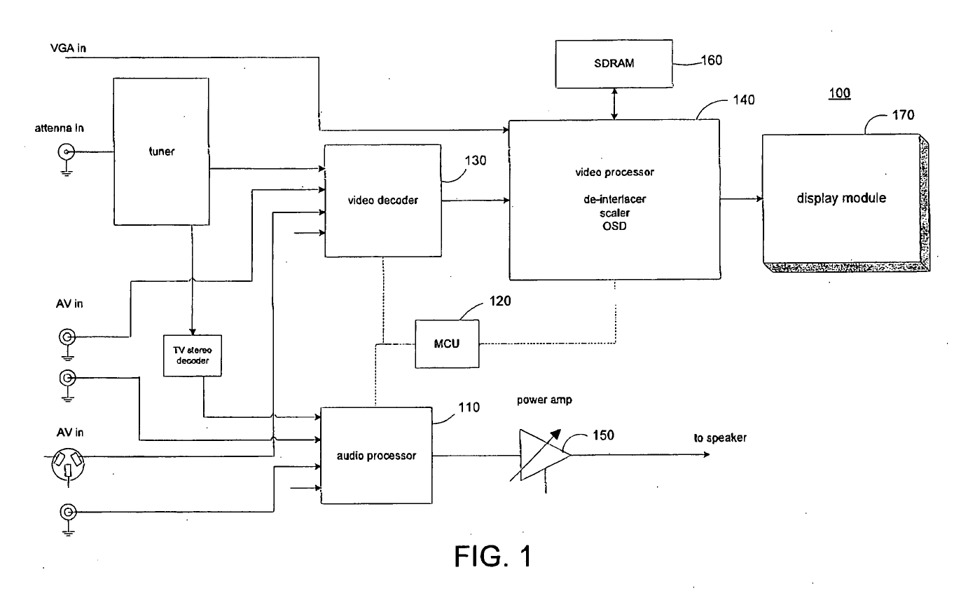

Refer to FIG. 1, which shows a preferred embodiment of a digital television (TV) set 100 capable of automatically controlling a sound level. In the embodiment of the invention, the proposed architecture for sound level control includes a digital circuit together with an analog to digital converter and a storage unit to constitute a simple and low cost audio sound level sense and control mechanism are implemented with the audio multiplexer, volume control, tone control in a single integrated circuit, as shown in the audio processor 110 in FIG. 1. The audio processor 110 selectively receives input data from external sources, for example, receiving an audio signal from a tuner or several AV plug audio in terminals, which depends on the TV set. A TV MCU 120 is connected to a video decoder 130 and a video processor 140. In an embodiment of the invention, the TV MCU 120 is further connected to the audio processor 110 for performing adjustment decision upon the data stored in the audio processor 110. The output of the audio processor 110 is transmitted to a power amplifier 150. The output of the power amplifier 150 is transmitted to a speaker of the TV set 100. The output of the video processor 140 which is connected to a memory unit 160 is transmitted to a display module 170 of the TV set 100.

The proposed system can be easily applied to other similar system applications, for example, a car audio system. It is dangerous for a driver to adjust the volume very often during channel change. With the same structure such situation can be reduced.

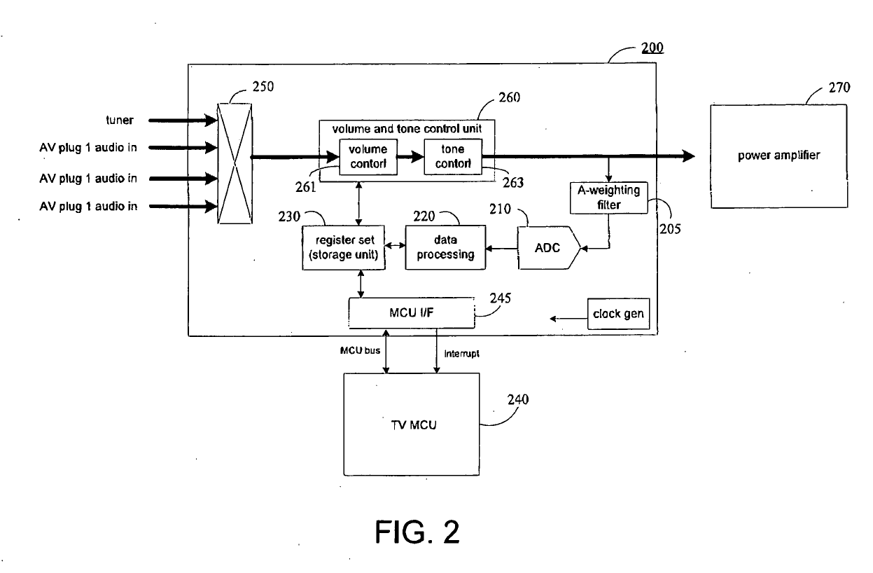

Refer to FIG. 2, which shows a preferred embodiment of architecture to achieve a low cost sound level control solution in a television (TV). The exemplary architecture of the embodiment is used for explaining the invention, but not used to restrict to the scope of the invention. As described above, the architecture to achieve a low cost sound level control solution can also be applied to other application systems, for example, in audio system circuitry applications or electrical devices with an audio system circuitry, or a car audio system, etc.

As shown in FIG. 2, the architecture for sound level control solution 200 includes an analog to digital converter (ADC) 210 for sensing an output volume level in the audio system circuitry application, a data processing digital circuit 220 for performing calculation on the sensing data, and a storage unit 230, for storing user settings and calculation results from the data processing digital circuit 220. The storage unit 230, for example, is a register set in an embodiment. As explained above, for reducing the cost, the calculations includes either a peak value memorizing calculation or a mean value calculation, or both, performed by the digital circuit. A TV microcontroller (MCU) 240 in the TV set can simply read the results and decide the adjustment. In the embodiment, a MCU interface 245 is interposed between the TV MCU 240 and the storage unit 230.

The architecture 200 further includes a receiving interface multiplexer 250 for selectively receiving input data from external sources, for example, receiving an audio signal from a tuner or several AV plug audio in terminals, which depends on the TV set. The source audio signals received from the external sources are transmitted to the volume and tone control unit 260. After performing volume and tone controlling upon the received source audio signals, these controlled audio signals are transmitted to a power amplifier 270 and also fed back to the analog to digital converter (ADC) 210. In an embodiment, these controlled audio signals are alternatively fed back to the analog to digital converter (ADC) 210 through an A-weighting filter 205. The A-weighting filter 205 compensates the human psychoacoustic filter effect to let measurement result close to the sound level felt by TV set users. The ADC 210 senses an output volume level of the controlled audio signals from the volume and tone control unit 260 and sends the sensing results to the data processing digital circuit 220.

In an embodiment, as shown in FIG. 2, the source audio signals received from the external sources are measured by the ADC 210 before being transmitted to the volume and tone control unit 260. In another embodiment, the source audio signals received from the external sources are transmitted to a volume control unit 261 of the volume and tone control unit 260. After performing a volume control function upon the received source audio signals, the volume-control source audio signals are transmitted to a tone control unit 263 of the volume and tone control unit 260 for tone controlling. The audio signals output from volume-control unit 261 are transmitted to the ADC 210 for signal sensing. The designs are dependent on the implementation requirements for the architecture for sound level control solution 200.

The source audio signals received from the external sources are transmitted to the volume and tone control unit 260. After performing volume and tone controlling upon the received source audio signals, these controlled audio signals are transmitted to a power amplifier

The data processing digital circuit 220 performs calculations upon the sensing result; for example, perform either a peak value memorizing calculation or a mean value calculation during a user-programmable period, or both. The calculation results are stored in the storage unit 230. The TV MCU 240 reads the result stored in the storage unit 230 through the MCU interface 245 and adjusts the sound level of the TV. In an embodiment, the calculation performed by the data processing unit 220 in the architecture 200 includes two sets of calculation circuits with different programmable periods, wherein one is used for quick adjust and the other is used for fine tune. In an embodiment, an interrupt signal is sent to the TV MCU 240 when the peak signal exceeds a user preset upper bound value. It can release the TV MCU 240 from continuously checking the peak value for the situation when user wants to control the sound level under a certain level.

In the embodiment, since the control decision is left to TV MCU 240, there is flexibility for TV sound level control mechanism. For example, even playback in the same channel, the sound level in a program session and the sound level in an advertisement session are sometimes very different. To maintain a same sound level in different sessions of the same TV channel, this sound level control device can be enabled in such situation even there is no channel switch.

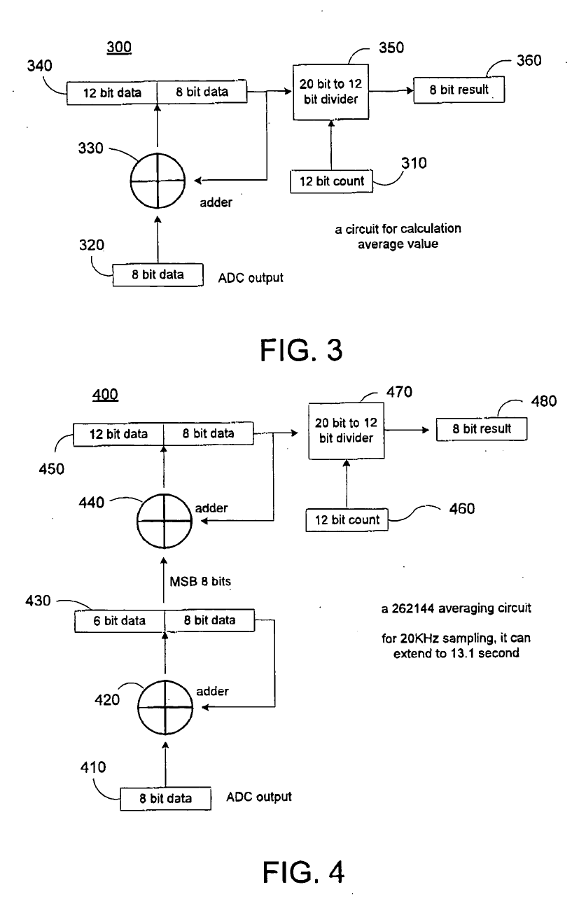

Refer to FIG. 3, which shows a preferred embodiment of the data processing unit 220 shown in FIG. 2. The data processing unit 220 in the embodiment can be implemented by an average calculation circuit 300. A programmable counter, for example, a 12-bit programmable counter 310, stores the length of user programmed calculation length up to 4096. For each data 320 sent from an 8-bit analog to digital converter, an adder 330 performs one add computation and stores the result therefrom in a register, for example, a 20-bit register 340. When the number of add computation reaches the count number in the 12 bit programmable counter 310, the computation result is sent to a divider, for example, a 20-bit to 12-bit divider 350, to divide the addition result by the value in programmable counter. After performing 20-bit to 12-bit dividing, the division computation result is then stored in a register, for example, a 8-bit register 360. Then the computation circuit stopped.

Refer to FIG. 4, which shows another preferred embodiment of the data processing unit 220 shown in FIG. 2. The data processing unit 220 in the embodiment can be implemented by a 2-stage average calculation circuit 400. To have a longer period of averaging calculation, the embodiment in FIG. 3 needs a very large divider circuit since the dividend bit number will be very long. To overcome this problem, a 2-stage circuit can be used. In the first stage circuit for each data 410 sent from an 8-bit analog to digital converter, an adder 420 performs one add computation and stores the result therefrom in a register, for example, a 14-bit register 430. After 64 input data have been calculated, the most significant bits (MSB) 8 bits are sent to the second stage circuit. In the second stage circuit, an adder 440 performs one add computation upon the MSB 8 bits sent from 430 and the data stored in a register, for example, a 20-bit register 450, and then the computation result therefrom is stored in the 20-bit register 450. When the number of add computation in adder 440 reaches the count number in the 12 bit programmable counter 460, the computation result is sent to a divider, for example, a 20-bit to 12-bit divider 470. After performing 20-bit to 12-bit dividing, the division computation result is then stored in a register, for example, a 8-bit register 480. Then the computation circuit stopped.

For the embodiment of FIG. 4, the first stage is a fixed 64 data average calculation circuit. And its calculation result is sent to the second average calculation circuit. A user programmable counter sets the calculation count for the second average calculation. Therefore, user programmable period has a unit step of 64 data. For the embodiment of FIG. 4, an average calculation capability for up to 262144 data can be reached, which can extend to 13.1 second for a high speed 20 KHz data sampling.

In an embodiment of the invention, control of the average calculation period is not by user programmable counter, but from the start and stop command of a system processor (e.g. a TV MCU).

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. An audio system circuitry for sound level control, comprising:
an analog to digital converter for sensing a volume level in the audio system circuitry and output sensing results;
a data processing digital circuit, connected to the analog to digital converter, for performing a calculation upon the sensing results and sending out calculation results; and
a storage unit, for storing user settings and the calculation results, whereby the sound level of the audio system circuitry is controlled in according to the calculation results.

2. The audio system circuitry of claim 1, wherein the audio system circuitry is installed in a television (TV) set.

3. The audio system circuitry of claim 1, wherein the audio system circuitry is installed in a car audio system.

4. The audio system circuitry of claim 1, wherein the calculation performed by the digital circuit is a mean value calculation.

5. The audio system circuitry of claim 4, wherein the mean value calculation is done with a sampling rate higher than 1 KHz.

6. The audio system circuitry of claim 1, wherein the calculation performed by the digital circuit is a peak value memorizing calculation.

7. The audio system circuitry of claim 6, wherein the peak value memorizing is done with a sampling rate higher than 1 KHz.

8. The audio system circuitry of claim 6, wherein there is an interrupt signal sent to the system processor when the peak value exceeds a user preset value.

9. The audio system of claim 1, wherein the calculation period is user programmable.

10. The audio system circuitry of claim 1, wherein the calculation performed by the digital circuit comprising two sets of calculation circuits with different programmable periods, wherein one is used for quick adjust and the other is used for fine tune.

11. The audio system circuitry of claim 1, wherein the audio system circuitry for sound level control is integrated with audio multiplexer, volume control, tone control into a single integrated circuit (IC).

12. The audio system circuitry of claim 1, wherein the audio system circuitry for sound level control is integrated with MCU, audio multiplexer, volume control, tone control into a single integrated circuit (IC).

13. The audio system circuitry of claim 1, wherein the audio system circuitry for sound level control is integrated with MCU, audio multiplexer, volume control, tone control, sound effect processing into a single integrated circuit (IC).

14. The audio system circuitry of claim 1, further comprising a volume and tone control unit, for receiving an input signal of the audio system circuitry and performing a volume and tone control upon the received input signal, wherein the analog to digital converter is connected to the volume and tone control unit for sensing output of the volume and tone control unit.

15. The audio system circuitry of claim 1, further comprising a volume and tone control unit, for receiving an input signal of the audio system circuitry and performing a volume and tone control upon the received input signal, wherein the analog to digital converter senses the volume level of the input signal of the audio system circuitry.

16. The audio system circuitry of claim 1, further comprising a volume and tone control unit, for receiving an input signal of the audio system circuitry and performing a volume control function and a tone control function upon the received input signal, wherein the analog to digital converter senses the volume level of the input signal which is performed with the volume control by the volume and tone control unit.

17. A television set capable of automatically controlling a sound level, wherein the television set comprising an audio system circuitry, wherein the audio system circuitry comprising:
an analog to digital converter for sensing a volume level in the audio system circuitry and output sensing results;
a data processing digital circuit, connected to the analog to digital converter, for performing a calculation upon the sensing results and sending out calculation results; and
a storage unit, for storing user settings and the calculation results, whereby the sound level of the audio system circuitry is controlled in according to the calculation results.

18. The television set of claim 17, wherein the calculation performed by the digital circuit is a mean value calculation.

19. The television set of claim 18, wherein the mean value calculation is done with a sampling rate higher than 1 KHz.

20. The television set of claim 17, wherein the calculation performed by the digital circuit is a peak value memorizing calculation.

21. The television set of claim 20, wherein the peak value memorizing is done with a sampling rate higher than 1 KHz.

22. The television set of claim 20, wherein there is an interrupt signal sent to the system processor when the peak value exceeds a user preset value.

23. The television set of claim 17, wherein the calculation period is user programmable.

24. The television set of claim 17, wherein the calculation performed by the digital circuit comprising two sets of calculation circuits with different programmable periods, wherein one is used for quick adjust and the other is used for fine tune.

25. The television set of claim 17, further comprising a volume and tone control unit, for receiving an input signal of the audio system circuitry and performing a volume and tone control upon the received input signal, wherein the analog to digital converter is connected to the volume and tone control unit for sensing output of the volume and tone control unit.

26. The television set of claim 17, further comprising a volume and tone control unit, for receiving an input signal of the audio system circuitry and performing a volume and tone control upon the received input signal, wherein the analog to digital converter senses the volume level of the input signal of the audio system circuitry.

27. The television set of claim 17, further comprising a volume and tone control unit, for receiving an input signal of the audio system circuitry and performing a volume control function and a tone control function upon the received input signal, wherein the analog to digital converter senses the volume level of the input signal which is performed with the volume control by the volume and tone control unit.

28. The television set of claim 17, wherein the data processing digital circuit for performing the calculation upon the sensing results is determined by a start and stop command of a system processor in the television set.
